(19) United States
(12) Patent Application Publication
(10) Pub. No.: US 2011/0168878 A1
(43) Pub. Date: Jul. 14, 2011

(54) METHOD AND APPARATUS FOR EMPIRICAL DETERMINATION OF A CORRECTION FUNCTION FOR CORRECTING BEAM HARDENING AND STRAY BEAM EFFECTS IN PROJECTION RADIOGRAPHY AND COMPUTED TOMOGRAPHY

(75) Inventors: Klaus Hoerndler, Nuernberg (DE); Christof Fleischmann, Moehrendorf (DE); Marc Kachelriess, Nuernberg (DE); Ludwig Ritschl, Erlangen (DE)

(73) Assignee: Ziehm Imaging, GmbH, Nurnberg (DE)

(21) Appl. No.: 12/948,718

(22) Filed: Nov. 17, 2010

(30) Foreign Application Priority Data
Nov. 17, 2009 (DE) DE 102009053664

(51) Int. Cl. G01D 18/00

(52) U.S. Cl. 250/252.1

(57) ABSTRACT

Methods for empirical determination of a correction function for correcting beam hardening and stray beam effects of water-equivalent tissue in projection radiography or computed tomography using an imaging detector, and apparatuses for implementing the same are disclosed. The projection values obtained from the logarithmic values of the detector signals are corrected, the corrected projection values being represented by a correction function dependent on the tube voltage applied during the X-ray projection recording, the coefficients of which function are determined from a single calibration scan on an object-like calibration phantom made of water-like material.

### CROSS-REFERENCE TO RELATED APPLICATIONS

This application claims the benefit of priority of German Patent Application No. DE102009053664, filed on Nov. 17, 2009, which is hereby incorporated by reference in its entirety.

### FIELD OF THE INVENTION

The invention relates to a method and apparatus for empirical determination of a correction function for correcting beam hardening and stray beam effects in projection radiography and computed tomography using an imaging detector.

### BACKGROUND AND SUMMARY OF THE INVENTION

It is known that in projection radiography and computed tomography with an imaging detector, quite similar image effects result from beam scattering and from spectral beam hardening that depend on the X-ray tube voltage and the primary filtering. Although the basic physical principles of the effects are quite different, the image effects of the so-called cupping from both causes can be indistinguishable from one another in practice.

Ideally, the fact that the beam scattering effect and the effect of beam hardening should be taken into account by a single correction function dependent on the tube voltage that is superimposed on the projection values obtained from the logarithmic values of the detector signals. The coefficients of the correction function can be determined from a single calibration scan with variable tube voltage on an object-like calibration phantom made of water-like material. The empirically determined coefficients can be obtained under the assumption that the reconstruction of an elliptical cylinder phantom made of water-like material from the projection images of the scan obtained with different tube voltages is homogeneous.

The hardening of the X-ray beam while penetrating the absorbing object has the effect that, in reconstructed axial images, the image elements towards the center of the image are reconstructed with decreasing gray levels. This so-called cupping effect prevents a homogeneous image impression. The cupping effect is avoided if the projection data is recalculated using an imaginary mono-energetic X-ray radiation. This recalculation for soft tissues takes place in a pre-reconstructive step with subsequent image reconstruction.

In contrast to radiography, stray radiation in computer tomography (CT) reconstructions not only leads to a deterioration of the signal-to-noise ratio but also to object-dependent gray level distortions such as cupping and bar or shadow artifacts, which can severely impair both the quantitative precision and the recognizability of low contrasts.

A two-stage method for correction of polychromatic beam hardening and stray radiation in X-ray projection recordings of a scan is disclosed in DE102005028216A1, wherein it is provided in a first step that a water pre-correction is performed on the projection values calculated from the logarithmic values of the detector measurement values, wherein each projection value is corrected additively or by multiplication by a stored correction value.

A method for accelerating the correction of stray beams is disclosed in German Patent No. DE102005053498B4, in which the projection values obtained from the logarithmic values of the attenuation data are corrected with a beam hardening term and the stray radiation correction is taken into account as an amplification factor for the beam hardening correction term.

A method for multiplicative stray radiation correction in X-ray imaging is disclosed in the unexamined German patent application DE102006040852A1, in which correction values that are obtained from a series expansion of a logarithm are subtracted from the logarithmic values of the measurement signals from the X-ray detector.

Performing a combined stray radiation and hardening correction in addition to other pre-corrections is disclosed in the unexamined German patent application DE102006021373A1.

A method for stray radiation correction in which the logarithmic measurement values are multiplied by a correction factor is disclosed in German Patent No. DE19523090C1.

A method for automatic control of the X-ray dose rate for producing an image in computed tomography is disclosed in the German patent application DE102004042060A1, in which the tube voltage is automatically adjusted for a tube current that has predetermined and stored specific to an object.

A method for combined beam hardening and stray radiation correction for objects with at least 2 material components is disclosed in the unexamined German patent application DE102006046047A1.

An experimental method for stray beam correction is disclosed in EP660599B2, in which an experimentally determined stray beam image is subtracted from the logarithmic values of the image data.

A method for empirical determination of a cupping function to eliminate beam hardening and stray beam induced effects of image data from a two-dimensional solid-state X-ray detector is disclosed in DE102005018660B4.

A calibration method for multispectral tomography is disclosed in DE102006049664A1.

Measuring the tube voltage and performing the hardening correction according to the measured tube voltage in order to correct the beam hardening effects, which depend sensitively on the acceleration voltage of the X-ray tubes, is disclosed in U.S. Pat. No. 5,400,387A.

A stray beam correction, in which a stray beam matrix dependent on the X-ray tube voltage and object properties is subtracted from the original image, is disclosed in DE68911072T2.

A method for creating material-selective volume images, in which an object is imaged with a C-arm X-ray device from different projection directions and in different energy ranges and in which the projection images obtained by back-projection of the reconstructed volume images are corrected, is disclosed in DE102007046359A1 (paragraph [0030]).

A method for bone density measurement in which X-ray images are obtained for at least two tube voltages with a storage phosphor screen and, after readout, logarithm calculation and digitization, the digital image signals are corrected with respect to the beam hardening effects using subtraction of correction image signals is disclosed in U.S. Pat. No. 5,418,373A.

A method for stray beam correction, in which object-specific convolution kernels are applied to the detected data generated during the irradiation through these objects is disclosed in DE102006045722A1.

A method for empirical correction of the beam hardening and the stray radiation in a water-like object, in which polychromatic X-ray retardation spectra with equal limit energy are used, is disclosed in the journal article “Empirical Cupping Correction” (M. Kachelrieβ, K. Sourbelle, and W. Kalender, “Empirical cupping correction: A first order rawdata [sic] precorrection for cone-beam computed tomography,” Med. Phys., Vol. 33, No. 5, pp. 1269-1274, May 2006).

In one aspect, the present disclosure provides a method for empirical determination of a correction function for correcting beam hardening and stray beam effects of water-equivalent tissue of an examination object in projection radiography or in computed tomography. The method involves using an X-ray recording unit constructed from a polychromatic X-ray beam source with a variable acceleration voltage U, an imaging digital X-ray detector and an image processing computer, and at least one cylindrical calibration phantom made of water-like material. The calibration phantom has an elliptical footprint arranged in the area of an X-ray beam cone between the X-ray beam source and the X-ray detector, with an axis of calibration phantom lying perpendicular to a central beam running between the focus of the X-ray beam source and the center point of the X-ray detector, the calibration phantom having a shape similar to the examination object in the area of the beam cone. The method comprises first taking X-ray projection images of the calibration phantom from a plurality of different angles between the major axis of the ellipse and the central beam of the X-ray recording unit. This may be carried out in the form of a calibration scan of the calibration phantom at different acceleration voltages and stored in a memory of the image processing computer. The volume of the calibration phantom in a voxel with a vector r may be reconstructed from the projection images of the calibration scan by means of an inverse radon transformation R−1 with the condition n=k·L+1:

$$\begin{matrix}f ( r ) = {R}^{- 1} p ( q , U ) \\ = {\sum }_{k , l = 0}^{K , L} {R}^{- 1} ( {c}_{k , l} {q}^{k} {U}^{l} ) \\ = {\sum }_{k , l = 0}^{K , L} {c}_{k , l} {f}_{k , l} \\ = {\sum }_{n = 1}^{N = ( K + 1 ) ( L + 1 )} {c}_{n} {f}_{n}\end{matrix}$$

A template image t(r), in which the areas with air and water are separated and set to predetermined constant gray levels, may be allocated to an artifact-affected reconstructed image, wherein the artifact-affected reconstructed image f(r) reconstructed from corrected data satisfies the following condition:

$${E}^{2} = {\sum }_{r} w ( r ) {( f ( r ) - t ( r ) )}^{2} = min$$

where w(r) is a weighting image with the values 0 and 1. The equation for E² is differentiated with respect to cₙ, from which a system of linear equations a=B·c results, where

$${a}_{n} = {\sum }_{r} w ( r ) t ( r ) {f}_{n} ( r )$$

$${B}_{nm} = {\sum }_{r} w ( r ) {f}_{n} ( r ) {f}_{m} ( r )$$

By inverting B, the desired coefficient vector c according to

c=B⁻¹·a

may be determined and thus a polynomial correction function

$$p ( q , U ) = {\sum }_{k , l}^{ } {c}_{k , l} {q}^{k} {U}^{l}$$

may be determined. The polynomial correction function determined for a range of acceleration voltages of an X-ray tube may be stored in a look-up table (LUT) allocated to the calibration phantom. Next, in the range of acceleration voltages used in the scan for each of the at least one calibration phantom a on which the function is based, a rational function

$$p ( U , α , q ) = \frac{{c}_{0} ( U , α ) + {c}_{1} ( U , α ) q + … + {c}_{n} ( U , α ) {q}^{n}}{1 + {d}_{1} ( U , α ) q + … + {d}_{n - 1} ( U , α ) {q}^{n - 1}}$$

with the secondary condition

$$\frac{{c}_{n}}{{d}_{n - 1}} = \frac{μ ( {E}_{0} )}{μ ( eU )}$$

may be fitted to the polynomial correction function. The coefficients of the rational function may be stored in the look-up table (LUT) allocated to the calibration phantom α. This process may be repeated for additional calibration phantoms of different geometry, until a sufficient number of LUT's for different calibration phantoms has been determined.

In one embodiment, the acceleration voltage during the calibration scan is varied by an automatic amplification and a dose rate regulation of the X-ray beam source in such a manner that the generated projection images have improved contrast and brightness relative to projection images without automatic amplification and dose rate regulation of the X-ray beam source.

In another embodiment, the acceleration voltage during the calibration scan may be controlled by a controller such that discrete, equidistant intermediate values between an upper and a lower acceleration voltage are used with identical frequency for recording the projection images of the calibration phantom.

In another embodiment, the LUT allocated to one of the at least one calibration phantom that is most similar to the examination object may be selected. Second, the polynomial correction function may be applied to a logarithmic attenuation value q of each pixel if the acceleration voltage applied to the X-ray tube in a projection recording lies within the range of acceleration voltages covered in the calibration scan. The rational function may be applied to the logarithmic attenuation value q of each pixel of the projection recording if the acceleration voltage applied to the X-ray tube in the projection recording lies outside the range of acceleration voltages covered in the calibration scan.

In another embodiment, the present disclosure provides an apparatus configured to conduct a method of empirically determining a correction function for correcting beam hardening and stray beam effects of water-equivalent tissue of an examination object in projection radiography or in computed tomography. The apparatus comprises an X-ray recording unit constructed from a polychromatic X-ray beam source with a variable acceleration voltage U, an imaging digital X-ray detector and an image processing computer with associated memory, the memory including a look-up table.

In another aspect, the present disclosure provides a method for correcting beam hardening and stray beam effects in projection radiography or computed tomography, comprising: performing a calibration scan by taking X-ray projection images of a plurality of calibration phantoms with an X-ray recording unit from a plurality of different angles relative to a central beam of the X-ray recording unit at a plurality of different acceleration voltages; for each calibration phantom, determining a polynomial correction function for a range of acceleration voltages for an X-ray tube of the X-ray recording unit; for each calibration phantom, fitting a rational function to the polynomial correction function; and storing the rational function associated with each of the calibration phantoms in a look-up table in a memory.

In an embodiment, the present disclosure provides an X-ray apparatus comprising the memory and look-up table.

In an embodiment, the present disclosure provides a method of selecting one of the calibration phantoms from the look-up table to geometrically correspond to an object to be scanned, scanning the object to produce image date, and producing a corrected image by applying to the image date the rational function corresponding to the selected calibration phantom.

### BRIEF DESCRIPTION OF THE DRAWINGS

FIG. 1 is a computer tomography (CT) image of a water phantom determined from uncorrected projection values q (simulation). The tube voltage varied between 40 kV (semi-minor axis) and 110 kV (semi-major axis).

FIG. 2 is a template image t(r) produced from uncorrected projection values. Gray levels: air=−1000 HU; water=0 HU (corresponds to Hounsfield units).

FIG. 3 is a weighting image w(r) generated from uncorrected projection values. The white areas have the value 1, the gray ones the value 0.

FIG. 4 is a series of base images f_{k,l}(r)=fₙ(r).

FIG. 5 is an corrected image (fr), which has been corrected by the methods of the disclosed embodiment.

FIG. 6 is a schematic block diagram of an apparatus, configured to correct image effects from beam hardening and stray beam effects, in accordance with an embodiment.

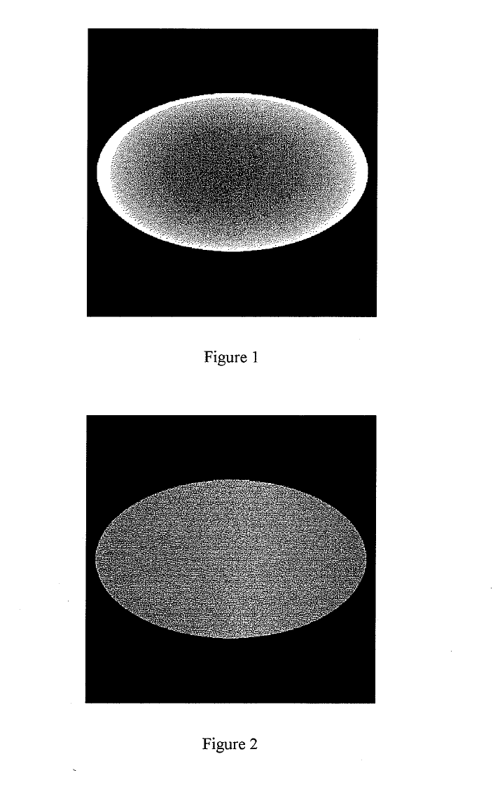

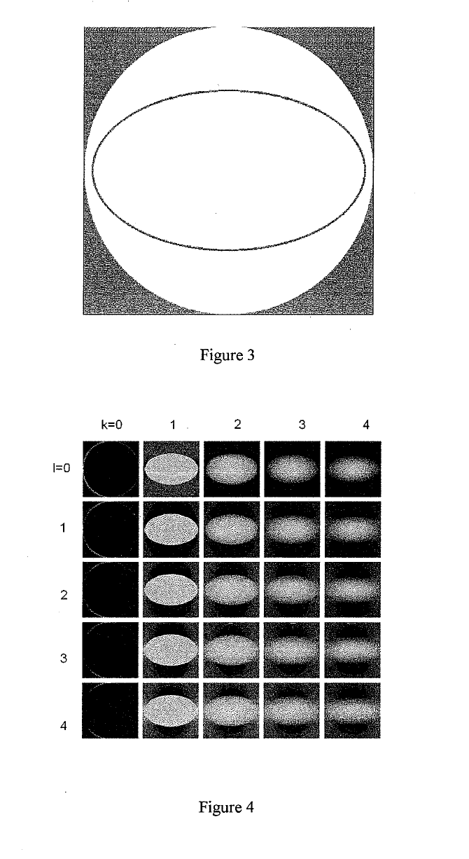

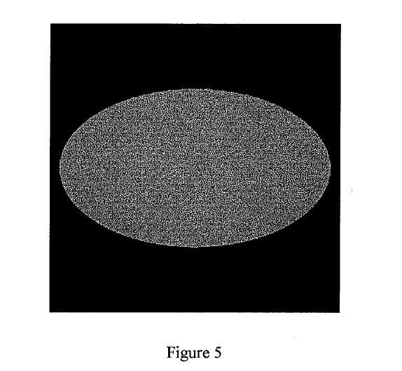

### DETAILED DESCRIPTION

One problem with the state of the art in projected radiography and in computed tomography is the need to find an economical and fast-operating method for empirical correction of the beam hardening of polychromatic X-ray retardation spectra with different limit energies on a water-like object.

Embodiments disclosed herein apply a correction function that depends on the acceleration voltage of the X-ray tube for a projection image to the projection values qi formed from the logarithmic measured values of the intensity, and by obtaining the correction function from the projection images of the single scan with variable acceleration voltage on an object-like calibration phantom made from a water-equivalent material.

Certain embodiments of the invention will be described in detail based on the theoretical relationships below. Only the part of the theory that goes beyond derivation of the correction function for a polychromatic X-ray spectrum with a defined limit energy from the journal article “Empirical Cupping Correction” (M. Kachelrieβ, K. Sourbelle, and W. Kalender, “Empirical cupping correction: A first order rawdata [sic] precorrection for cone-beam computed tomography,” Med. Phys., Vol. 33, No. 5, pp. 1269-1274, May 2006) will be presented. The entirety of the Kachelrieβ et al. article is incorporated herein by reference for purposes of providing background theory.

The physical law on which the considerations build is the Lambert-Beer law, which describes the attenuation of a polychromatic X-ray beam in a material with the energy-dependent and material-dependent attenuation coefficients μ(E, r) along the path d. For the sake of simplicity, in the following we will assume homogeneous bodies made of a material with a constant density, so that the path d can be interpreted as the intersection length.

Iₐ=∫dEw(E)I₀e^{-μ(}E)d

where w(E) is the spectrum of the emitted X-ray beam normalized to 1:

$${\int }_{0}^{eU} d Ew ( E ) = 1$$

Iₐ is the intensity attenuated by the body, I₀ is the initial intensity of the X-ray beam, e is the elementary charge of an electron and eU is therefore the maximum achievable energy of an X-ray beam for a tube voltage U.

The intensity actually measured in the detector is composed of Iₐ and a stray beam component Iₛ. This stray beam component L is heavily dependent on the geometry and the material of the body to be measured. The parameters that influence L will be described below with the suffix α and will be specified in detail later.

The precision with which the stray beam component L is determined (i.e., the number of variables on which L depends) increases the precision of the pre-correction, since the ratio of Iₐ and Iₛ is not precisely known.

I=Iₐ+Iₛ

The following is defined as the polychromatic attenuation value:

$$\begin{matrix}q ( d , α ) = - ln \frac{I ( d , α )}{{I}_{0}} \\ = - ln \frac{( {I}_{A} ( d ) + {I}_{S} ( α ) )}{{I}_{0}} \\ = - ln \frac{( {I}_{A} ( 1 + \frac{{I}_{S} ( α )}{{I}_{A} ( d )} ) )}{{I}_{0}} \\ = - ln \int d Ew ( E ) {e}^{- μ ( E ) d} - ln \frac{1 + \frac{{I}_{S} ( α )}{{I}_{A} ( d )}}{{I}_{0}} \\ = - ln \int d Ew ( E ) {e}^{- μ ( E ) d} + {δ}_{S} ( d , α )\end{matrix}$$

where δs is the stray beam component in the space of the logarithmic values of the data.

For polychromatic radiation, q is a nonlinear function of d.

A linear relationship exists only for a monochromatic spectrum and without stray radiation:

w(E)=δ(E−E₀)

where δ(x) is the Dirac delta function.

The energy E₀ is freely selectable. Thus it holds for equation (2) that

q_{E}_{₀}(d):=p(d)=μ(E₀)d

Since p and d differ only by a constant of proportionality, the variable d will no longer be used below.

This linear relationship can be employed to reconstruct correct computed tomography images (CT images) from projection images. Since monochromatic spectra cannot be realized technically with X-ray tubes and stray radiation components are to be taken into account, the polychromatic attenuation values should be correspondingly pre-corrected (linearized). Therefore a correction function p(q, α) should recalculate the polychromatic and stray radiation-affected attenuation values to monochromatic ones. Water is used as a reference material for this, and therefore this method is also known as water correction. The above considerations assume that the emitted spectrum w(E) for all projections of the scan is constant. The “ECC” method is likewise provided for a constant spectrum.

In the case of a variable X-ray voltage U, the spectrum w(E, U) is no longer constant, but is instead dependent on the tube voltage U. Thereby one obtains an attenuation value q(p, U, α) for the irradiated object that is dependent not only on the object material and the object thickness, but also on the spectrum or the voltage. A separate correction function p(q, α, U) is likewise employed for each value of the tube voltage.

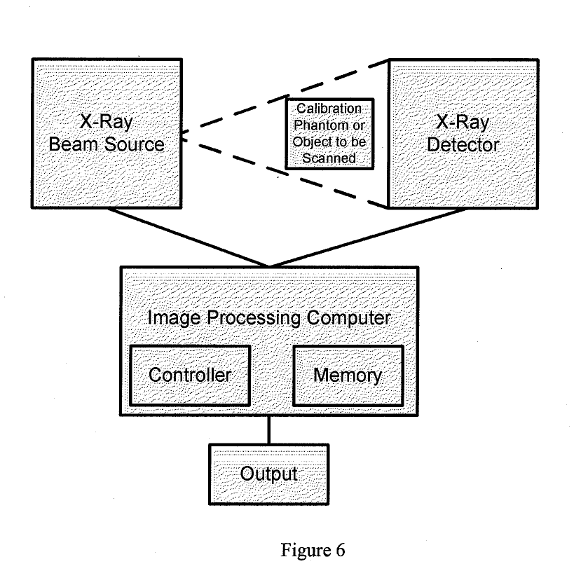

A method for doing this is described in the unexamined German patent application DE102005028216A1. It is provided there that the function p(q, U) is stored in the form of discrete values in a memory, as depicted in FIG. 6. The uncorrected values q are corrected with the corresponding values from the memory.

The below-described method allows a simple determination of the correction function p(q, U, α), taking into account the stray beam properties of the calibration body, wherein the correction function obtained can be applied with a low computational cost to the logarithmic measured values of the pixel values in the raw image.

The embodiments described herein employ a solution for the unknown function p(q, U, α) that proceeds from a linear combination of base functions, preferably polynomials. The correction function approximated as a polynomial does not have the same monotonic behavior as the unknown function p(q, U, α). By choosing other base functions that better correspond to the underlying physical model, this can be prevented, so that a correct extrapolation of the function into value ranges that are not covered by measured values, but are relevant, is possible.

Functions that can be considered as possible base functions are those that have the following properties in p(q, U):

p(q, U) increases monotonically with U

p(q, U) increases with q

The first derivative of p(q, U) with respect to q is positive, monotonically increasing and converges at infinity to the value μ(E0)/μ(eU), since then q=μ(eU)*d (after infinite material thickness the beam is theoretically monochromatic, but then no measurable intensity remains in reality) and p=μ(E0)*d by definition, where eU is the maximum energy of the tube and E0 is a freely selectable energy value to which the calibration is made.

In order to satisfy the desired monotonous behavior of the sought-for function p(q, U, α), it is provided that the polynomial functions are replaced with a more suitable function after their determination.

The following approach fulfills the above-mentioned criteria:

$$p ( U , α , q ) = \frac{{c}_{0} ( U , α ) + {c}_{1} ( U , α ) q + … + {c}_{n} ( U , α ) {q}^{n}}{1 + {d}_{1} ( U , α ) q + … + {d}_{n - 1} ( U , α ) {q}^{n - 1}}$$

In addition that the condition:

$$\frac{{c}_{n}}{{d}_{n - 1}} = \frac{μ ( {E}_{0} )}{μ ( eU )}$$

can be imposed for the function to converge to the desired value.

This function is not used directly as a base function since, as a rational function, it does not represent a linear combination. Instead, the rational function is fitted for each value of U and α to the previously determined polynomial in the measured value range. Due to the introduced boundary condition and the other behavior of the rational function, a correct behavior outside the measured values also exists.

Images of a later scan can be corrected by means of a polynomial function so long as the values for the limit voltage of the X-ray retardation spectrum for the respective image are inside the range of limit voltages used for the calibration with a water phantom of similar geometry. For all cases in which the limit voltage for an image in a scan lies outside the range of limit voltages used in the calibration, the beam hardening and stray beam effects can be corrected with the rational function fitted to the polynomial function.

The correction function p(q, U) is determined from projection images of a scan with a two-dimensional imaging detector for conical or pyramidal beam geometry of the X-ray beam.

For the calibration, different sized cylindrical bodies (calibration phantoms) of water-like material with an elliptical footprint can be used, each being characterized by the object-dependent parameter O. That is to say, a bundle of correction functions p_{O}(q, U) are obtained, each from a single scan on the calibration body O. This implies the assumption that the unknown scattering component also depends only on the variables q, U and O.

Only the stray radiation caused by water-like material is considered; strongly scattering structures in the interior of the object, such as vessels filled with radiocontrast agent, bones or metal parts are not considered.

The above-described elliptical water cylinders with a maximum height and whose cylindrical axis is oriented such that it is perpendicular to the central beam of the X-ray imaging unit are used for the calibration. It has been shown in practice that all functions for correcting the beam hardening and stray beam effects with sufficient precision can be determined with four different-sized calibration phantoms. The largest calibration phantom to be used for the calibration scans can be selected such that it is completely imaged in the scanning direction for defined detector dimensions and a defined focus-detector distance in the scanning direction. It has been found that the water pre-correction is more precise the more similar the calibration phantom is to the irradiated examination object.

More precise geometric details such as edges, at which scattering is particularly observable, are neglected in the determination of the correction function; therefore this is only an approximation to the correction of the stray beam component.

The parameter O will be neglected for the sake of simplicity below, since the calibration process is the same for different objects O.

$$p ( q , U ) = {\sum }_{k , l} {c}_{k , l} {q}^{k} {U}^{l}$$

The function sought is completely determined in this case by the coefficients c_{k,l}.

The projection data is back-projected into the volume for generating CT images by means of the inverse radon transformation R⁻¹:

$$\begin{matrix}f ( r ) = {R}^{- 1} p ( q , U ) \\ = {\sum }_{k , l = 0}^{K , L} {R}^{- 1} ( {c}_{k , l} {q}^{k} {U}^{l} ) \\ = {\sum }_{k , l = 0}^{K , L} {c}_{k , l} {f}_{k , l} \\ = {\sum }_{n = 1}^{N = ( K + 1 ) ( L + 1 )} {c}_{n} {f}_{n} ,\end{matrix}$$

with n=k·L+1.

The vector r relates to the volume into which the data is back-projected. Since the volume has been discretized, r represents a voxel. The fact that the back projection is linear with respect to the base functions makes it possible to reconstruct the base functions individually (fₙ) and execute the linear combination in the image space. Since the properties that the ideally reconstructed image should have—namely constant gray levels for areas of constant density and identical material—are known, the linear combination can be optimized in that regard. A template image t(r) can be constructed from the artifact-affected image by separating the air and water areas and setting them to the desired constant gray levels.

The image f(r) reconstructed from corrected data is intended to meet the following condition:

$${E}^{2} = {\sum }_{r} w ( r ) {( f ( r ) - t ( r ) )}^{2} = min$$

where w(r) is the weighting image with the values 0 and 1, which excludes areas outside the measurement field as well as edge transitions (point spread function inaccuracies) and areas in which there was no certain detection of material from the determination of the coefficients. In order to find the optional set of coefficients, which satisfies the above condition, E² is differentiated with respect to cₙ. This leads to the system of linear equations a=B·c, with

$${a}_{n} = {\sum }_{r} w ( r ) t ( r ) {f}_{n} ( r )$$

$${B}_{nm} = {\sum }_{r} w ( r ) {f}_{n} ( r ) {f}_{m} ( r )$$

The desired coefficient vector c can be determined by inverting B, since

c=B⁻¹·a.

It is advantageous that as large a bandwidth of limit voltages of the X-ray retardation spectrum (tube voltages) and of beam penetration lengths as possible is available for the calibration scan. The problem is solved by the similarity of the calibration phantom to the examination object, so that the voltages and attenuation values occurring in a subsequent scan are taken into account in the calibration.

For each pixel value qi, the function pi(qi, U) is calculated, where the adjusted tube voltage with which the X-ray projection image was recorded is used as the voltage. In practice it is the case that the dose rate regulation regulates the tube voltage in a fraction of the exposure time, so that the voltage variation during the settling time need not be considered.

After the termination of the recording of a projection, the individual pixel values that represent the measured intensity of the X-ray quanta are read out from the imaging detector, the logarithmic values of these pixel values are calculated and stored in a memory as a raw image. By definition

$$\begin{matrix}q ( p , U , O ) = - ln \frac{I ( p , U , O )}{{I}_{0}} \\ = - ln I ( p , U , O ) + ln {I}_{0}\end{matrix}$$

This means that all pixel values labeled qi are already logarithmic. Since the value I₀ is not known before a calibration, it makes sense to incorporate the offset ln(I₀) into the correction function (then corresponding to the q⁰ term in the polynomial, since this is a value dependent only on U that is added up); in this case

q=−ln I

is the measured logarithmic value uncorrected for beam hardening, stray radiation and I0 value.

For each value qi of the raw image, the function pi(qi, U) is calculated, wherein the regulated tube voltage is used as the voltage with which the X-ray projection image was taken. In practice it is the case that the dose rate regulation regulates the tube voltage in a fraction of the exposure time, so that the voltage variation during the settling time need not be considered.

From the bundle of correction functions, the one determined experimentally with a calibration phantom that most closely approximates the examination object in shape and thickness is selected. The object-dependent correction function can be selected automatically based on additional measurements on the object, or manually by an appropriate input procedure.

The application of the correction function p_{O}(q, U) to each individual pixel value qi yields a pre-corrected image with the values pi that represent the corrected logarithmic measured values.

After this pre-correction, the pre-corrected image is further processed according to the purpose for which it was taken, for example, together with additional pre-corrected X-ray projections for a 3D reconstruction of the object, for performing bone density measurements or for performing procedures for digital subtraction angiography (DSA).

The calculation process for pre-correction is started for each projection image after the termination of the recording process for this projection image, and is generally terminated at the time the subsequent projection image has been taken, so that the corrected projection image can be displayed and/or further processed in real time.

The calibration scan using the X-ray diagnostic device and a calibration phantom can be recorded in at least two ways:

1. If the X-ray diagnostic device has a possibility for being rotated around an examination object, for example, if the X-ray imaging unit is arranged on a multiply adjustable C-arm or in a cone-beam computed tomography unit, the calibration phantom can be stationary and the projection images can be obtained by moving the X-ray imaging unit.

2. In case of an X-ray imaging unit that is stationary, a unit that is movable but not suitable for a scan, or a unit that is movable and suitable for recording a scan, the calibration phantom can be arranged in such a manner that it lies inside the beam cone of the X-ray imaging unit and, in case of a stationary X-ray imaging unit, is moved stepwise about an axis of rotation that is perpendicular to the central beam running through the focus of the X-ray beam source and the center of the imaging X-ray detector, and parallel to the cylinder axis, and a projection image of the calibration phantom is recorded for each angular increment.

The calibration scan is composed of individual projection images of a calibration phantom that were obtained at different acceleration voltages of the X-ray tube.

The acceleration voltage during the calibration scan can be varied automatically by an automatic amplification and dose rate regulation of the X-ray diagnostic device in such a manner that the generated projection images have a sufficiently good contrast with adequate brightness. As depicted in FIG. 6, the controller may be configured to control the acceleration voltage.

It is contemplated that the acceleration voltage during the calibration scan can be controlled by means of a contemplated controller in such a manner that discrete, equidistant intermediate values between an upper and a lower acceleration voltage are used with identical frequency for recording the projection images of the calibration phantom.

By using a calibration phantom that is adjustable with respect to its rotational position relative to the central beam, any X-ray diagnostic device can be corrected with respect to empirical water correction.

The correction function p(q, U) is used as pre-correction for each attenuation value q of a pixel in a projection image of an examination object with similar dimensions to that of the calibration phantom, regardless of the fact that the examination object does not consist exclusively of a water-like material.

During the performance of pre-correction in practice, those look-up tables (LUT) of correction function coefficients are selected that are allocated to a calibration phantom which is most similar to the examination object. If the acceleration voltage applied to the X-ray tube in the projection recording lies within the range of acceleration voltages covered in the calibration scan, the polynomial correction function is used; if the acceleration voltage applied to the X-ray tube in the projection recording lies outside the range of acceleration voltages covered in the calibration scan, then the rational correction function fitted to the polynomial correction function is used.

FIG. 6 is a schematic block diagram of an apparatus according to an embodiment. An X-ray beam source is configured to emit X-rays incident to a calibration phantom or object to be scanned, and an X-ray detector is positioned to receive and detect the emitted X-rays. An image processing computer may contain both a controller for controlling the acceleration voltage of the X-ray beam source, as well as memory for storing the look-up tables for different calibration phantoms. Although in this Figure the controller and memory are both shown within the image processing computer, it will be understood by one of skill in the art that either or both the controller and memory may in fact be separate from the image processing computer. The output may be optionally a display monitor for displaying corrected images, memory, or hard copy in the form of X-ray film or other printed output.

Although the foregoing description of the preferred embodiments of the present invention has shown, described and pointed out the fundamental novel features of the invention, it will be understood that various omissions, substitutions, and changes in the form of the detail of the invention as illustrated as well as the uses thereof, may be made by those skilled in the art, without departing from the spirit of the invention.

What is claimed is:

1. A method for empirical determination of a correction function for correcting beam hardening and stray beam effects of water-equivalent tissue of an examination object in projection radiography or in computed tomography using
an X-ray recording unit constructed from a polychromatic X-ray beam source with a variable acceleration voltage U,
an imaging digital X-ray detector and an image processing computer,
at least one cylindrical calibration phantom made of water-like material with an elliptical footprint arranged in the area of an X-ray beam cone between the X-ray beam source and the X-ray detector, wherein:
an axis of the at least one calibration phantom lies perpendicular to a central beam running between the focus of the X-ray beam source and the center point of the X-ray detector,
the at least one calibration phantom has a shape similar to the examination object in the area of the beam cone,
wherein the method comprises:
a) taking X-ray projection images of the at least one calibration phantom from a plurality of different angles between the major axis of the ellipse and the central beam of the X-ray recording unit in the form of a calibration scan of the at least one calibration phantom at different acceleration voltages and stored in a memory of the image processing computer;
b) reconstructing the volume of the at least one calibration phantom in a voxel with a vector r from the projection images of the calibration scan by means of an inverse radon transformation R⁻¹ with the condition n=k·L+1:
$$\begin{matrix}f ( r ) = {R}^{- 1} p ( q , U ) \\ = {\sum }_{k , l = 0}^{K , L} {R}^{- 1} ( {c}_{k , l} {q}^{k} {U}^{l} ) \\ = {\sum }_{k , l = 0}^{K , L} {c}_{k , l} {f}_{k , l} \\ = {\sum }_{n = 1}^{N = ( K + 1 ) ( L + 1 )} {c}_{n} {f}_{n}\end{matrix}$$
allocating a template image t(r), in which the areas with air and water are separated and set to predetermined constant gray levels, to an artifact-affected reconstructed image, wherein the artifact-affected reconstructed image f(r) reconstructed from corrected data satisfies the following condition:
$${E}^{2} = {\sum }_{r} w ( r ) {( f ( r ) - t ( r ) )}^{2} = min$$
, where w(r) is a weighting image with the values 0 and 1;
differentiating the equation for E² with respect to cₙ, from which a system of linear equations a=B·c results, with
$${a}_{n} = {\sum }_{r} w ( r ) t ( r ) {f}_{n} ( r )$$
$${B}_{nm} = {\sum }_{r} w ( r ) {f}_{n} ( r ) {f}_{m} ( r )$$
inverting B, such that the desired coefficient vector c according to
c=B⁻¹·a.
is determined and thus a polynomial correction function
$$p ( q , U ) = {\sum }_{k , l} {c}_{k , l} {q}^{k} {U}^{l}$$
is determined;
determining the polynomial correction function for a range of acceleration voltages of an X-ray tube and storing said polynomial function in a look-up table (LUT) allocated to the calibration phantom;
c) fitting a rational function in the range of acceleration voltages used in the scan for each of the at least one calibration phantom a on which the function is based to the polynomial correction function from b), wherein the rational function is characterized by
$$p ( U , α , q ) = \frac{{c}_{0} ( U , α ) + {c}_{1} ( U , α ) q + … + {c}_{n} ( U , α ) {q}^{n}}{1 + {d}_{1} ( U , α ) q + … + {d}_{n - 1} ( U , α ) {q}^{n - 1}}$$
with the secondary condition
$$\frac{{c}_{n}}{{d}_{n - 1}} = \frac{μ ( {E}_{0} )}{μ ( eU )}$$
and storing the coefficients of the rational function in the look-up table (LUT) allocated to the calibration phantom a;
d) repeating a)-c) for additional calibration phantoms of different geometry, until a sufficient number of LUT's for different calibration phantoms has been determined.

2. A method for empirical determination of a correction function according to claim 1, characterized in that, in a), the acceleration voltage during the calibration scan is varied by an automatic amplification and a dose rate regulation of the X-ray beam source in such a manner that the generated projection images have improved contrast and brightness relative to projection images without automatic amplification and dose rate regulation of the X-ray beam source.

3. A method for empirical determination of a correction function according to claim 1, characterized in that, in a), the acceleration voltage during the calibration scan is controlled by a controller in such a manner that discrete, equidistant intermediate values between an upper and a lower acceleration voltage are used with identical frequency for recording the projection images of the calibration phantom.

4. A method for correcting beam hardening and stray beam effects of materials in X-ray projection images of an examination object, using correction functions determined according to claim 1, comprising:
a) selecting the LUT allocated to a calibration phantom that is most similar to the examination object; and
b) applying the polynomial correction function to a logarithmic attenuation value q of each pixel if the acceleration voltage applied to the X-ray tube in the projection recording lies within the range of acceleration voltages covered in the calibration scan, and applying the rational function to the logarithmic attenuation value q of each pixel of the projection recording if the acceleration voltage applied to the X-ray tube in the projection recording lies outside the range of acceleration voltages covered in the calibration scan.

5. A method for correcting beam hardening and stray beam effects of materials in X-ray projection images of an examination object, using correction functions determined according to claim 2, comprising:
a) selecting the LUT allocated to a calibration phantom that is most similar to the examination object; and
b) applying the polynomial correction function to a logarithmic attenuation value q of each pixel if the acceleration voltage applied to the X-ray tube in the projection recording lies within the range of acceleration voltages covered in the calibration scan, and applying the rational function to the logarithmic attenuation value q of each pixel of the projection recording if the acceleration voltage applied to the X-ray tube in the projection recording lies outside the range of acceleration voltages covered in the calibration scan.

6. A method for correcting beam hardening and stray beam effects of materials in X-ray projection images of an examination object, using correction functions determined according to claim 3, comprising:
a) selecting the LUT allocated to a calibration phantom that is most similar to the examination object; and
b) applying the polynomial correction function to a logarithmic attenuation value q of each pixel if the acceleration voltage applied to the X-ray tube in the projection recording lies within the range of acceleration voltages covered in the calibration scan, and applying the rational function to the logarithmic attenuation value q of each pixel of the projection recording if the acceleration voltage applied to the X-ray tube in the projection recording lies outside the range of acceleration voltages covered in the calibration scan.

7. An apparatus configured to conduct the method of claim 1, comprising
the X-ray recording unit constructed from a polychromatic X-ray beam source with the variable acceleration voltage U,
the controller configured to control the variable accelerator voltage,
the imaging digital X-ray detector, and
the image processing computer with associated memory, the memory including the LUT.

8. A method for correcting beam hardening and stray beam effects in projection radiography or computed tomography, comprising:
performing a calibration scan by taking X-ray projection images of a plurality of calibration phantoms with an X-ray recording unit from a plurality of different angles relative to a central beam of the X-ray recording unit at a plurality of different acceleration voltages;
for each calibration phantom, determining a polynomial correction function for a range of acceleration voltages for an X-ray tube of the X-ray recording unit;
for each calibration phantom, fitting a rational function to the polynomial correction function; and
storing the rational function associated with each of the calibration phantoms in a look-up table in a memory.

9. An X-ray apparatus comprising the memory and look-up table of claim 8.

10. A method of employing an X-ray apparatus, the method comprising
selecting one of the calibration phantoms from the look-up table of claim 8 to geometrically correspond to an object to be scanned;
scanning the object to produce image data; and
producing a corrected image by the applying to the image data the rational function corresponding to the selected calibration phantom.
